(19) United States
(12) Patent Application Publication
(10) Pub. No.: US 2015/0210143 A1
(43) Pub. Date: Jul. 30, 2015

(54) VANE AND AIR VENT

(71) Applicant: TRW Automotive Electronics & Components GmbH, Radolfzell (DE)

(72) Inventor: Michael Schlippe, Kaiserslautern (DE)

(21) Appl. No.: 14/599,584

(22) Filed: Jan. 19, 2015

(30) Foreign Application Priority Data
Jan. 30, 2014 (DE) 10 2014 101 145.7

(51) Int. Cl. B60H 1/34

(52) U.S. Cl. CPC B60H 1/3421

(57) ABSTRACT

A vane for an air vent includes at least one face side. The face side has at least one clip-in member provided thereon by means of which the vane can be clipped into an air vent.

The present invention relates to a vane for an air vent and to an air vent.

### BACKGROUND OF THE INVENTION

In air vents for motor vehicles, usually two packets of vanes are arranged behind each other and perpendicularly to each other for directing the air flow that flows out through the air vent.

In particular the vanes in the rear region of the air vent are fastened in the air vent housing by means of separate holding bars.

One example of such an air vent is known from DE 10 2011 120 915 A1. This air vent includes horizontally arranged front vanes (A-vanes) and vertically arranged vanes in the rear region (B-vanes), which are connected with each other via coupling members. The coupling members allow a swiveling movement of the vanes to be obtained as specified by an operating element, in order to orient the air flow out of the air vent.

This type of fastening may, however, result in that a rattling of the vanes may occur in operation. This noise development is perceived to be disturbing.

It is therefore the object of the invention to further develop a vane and an air vent of the type mentioned at the outset in an advantageous manner, more particularly to the effect that a low-noise operation of the air vent and a stable fixing of the vanes within the air vent housing is made possible.

### BRIEF DESCRIPTION OF THE INVENTION

In order to solve this problem, the invention provides a vane for an air vent, the vane having at least one face side. The face side has at least one clip-in member provided thereon by means of which the vane can be clipped into the air vent. Having the possibility of clipping the vane into the air vent will allow a low-noise operation of the air vent. Furthermore, the vanes are adapted to be stably fastened in the air vent in a simple manner by being clipped in. The vane may be a so-called B-vane, B-vanes are the vanes arranged in the rear region of the air vent, that is, on the side facing away from the vehicle interior.

Provision may further be made that the clip-in member includes a clip-in section which has a substantially cylindrical basic shape and widens at its end facing away from the vane. The widening of the end of the clip-in section facing away from the vane allows the clip-in member to be securely and stably fixed in place within the housing of the air vent.

Preferably, provision is made that the clip-in member is at least partly formed to have a mushroom head shape. Designing the clip-in member with a mushroom head shape allows a simple manufacture. In addition, the rounded shapes of the clip-in member having the mushroom head design allow the clip-in member to be simply clipped into the housing of the air vent, and the head of the clip-in member may serve as a mechanical stop in the longitudinal direction.

Advantageously, the vane may have two face sides, and both face sides may each have one clip-in member provided thereon. This provides a very stable fastening of the vanes within the housing.

Preferably, provision may be made that the two clip-in members are coaxial. The vane may then be swiveled about the clip-in members in the housing.

Preferably, the clip-in member is integrally molded with the vane. This results in the advantage that the vane can be manufactured simply and cost-effectively. In addition, thus only very few moving parts are arranged inside the air vent. This reduces the overall tendency of the vanes to develop noises within the air vent.

Advantageously, the clip-in member may include a shoulder defining a clip-in stop. The clip-in stop allows a unique assembly of the vane in the housing of the air vent. The shoulder may also rest directly against the inside of the air vent housing. This may result in that the vane can only be swiveled in relation to the air vent housing, whereas any axial movement along the swivel axis of the vane is prevented by the shoulder. This again reduces the undesirable noise development.

In particular, the shoulder may widen at its end facing away from the vane. The shoulder may be located between the face side and the clip-in member.

For example, provision may be made that the shoulder is at least partly formed to have a mushroom head shape. The rounded shapes of the design in a mushroom head shape allow a simple clip-in process and a secure grip, e.g. in the openings provided in the air vent housing.

Furthermore, the present invention relates to an air vent. According thereto, an air vent includes at least one vane according to the invention. In particular, all of the above-mentioned features and advantages of the vane described above and of the respective possible exemplary embodiments may be realized.

### BRIEF DESCRIPTION OF THE DRAWINGS

Further features and advantages of the invention will be apparent from the description below and from the accompanying drawings, to which reference is made and in which:

FIG. 1 shows a perspective view of an exemplary embodiment of an air vent according to the invention with an exemplary embodiment of vanes according to the invention;

FIG. 2 shows a perspective detail view of the air vent according to FIG. 1; and

FIG. 3 shows a side view of an exemplary embodiment of a vane according to the invention.

### DETAILED DESCRIPTION OF THE INVENTION

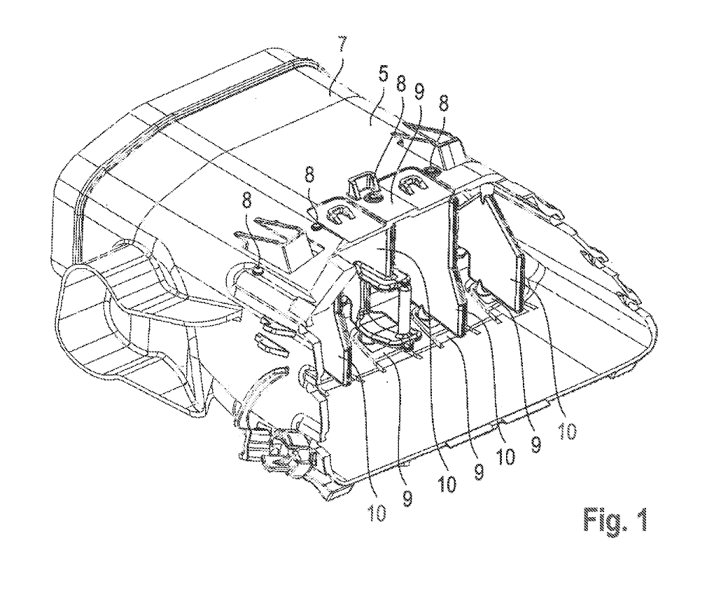

FIG. 1 shows an air vent 5 according to the invention in a perspective view.

The air vent 5 includes an air vent housing 7. Rear vanes 10 are arranged in the air vent housing 7 shown. These vanes are also referred to as B-vanes. The second set of vanes, that is, the so-called A-vanes arranged on the side facing the vehicle interior, are not illustrated here.

The air vent housing 7 has a plurality of openings 8 in which the vanes 10 are inserted. The openings 8 are located substantially centrally in insertion regions 9 which, in contrast to the other regions of the inside of the air vent housing 7, have a lower wall thickness.

Viewed in a top view, the insertion regions 9 are substantially U-shaped regions on the inside of the air vent housing.

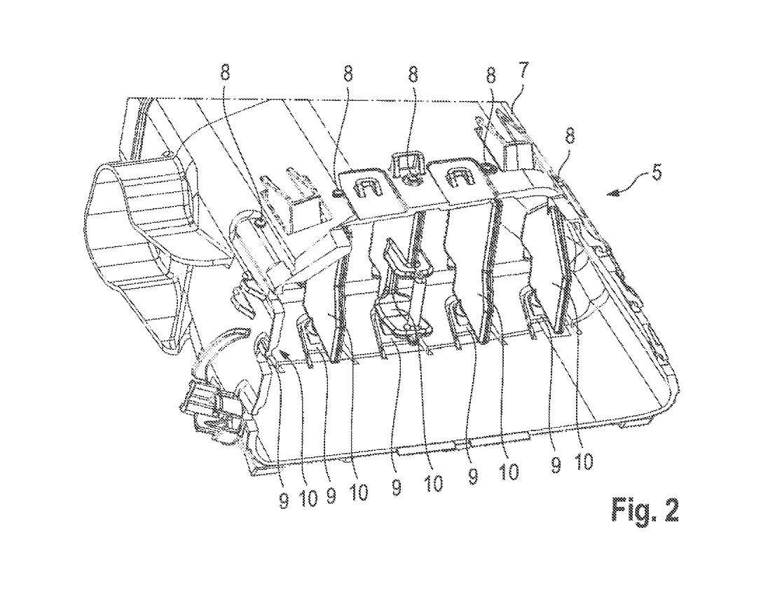

The air vent housing 7 is usually made from a thermoplastic material. FIG. 2 shows a further perspective view of the air vent 5.

Five vanes 10 are arranged in the air vent 5, one vane 10 being substantially concealed by the air vent housing 10 in this perspective.

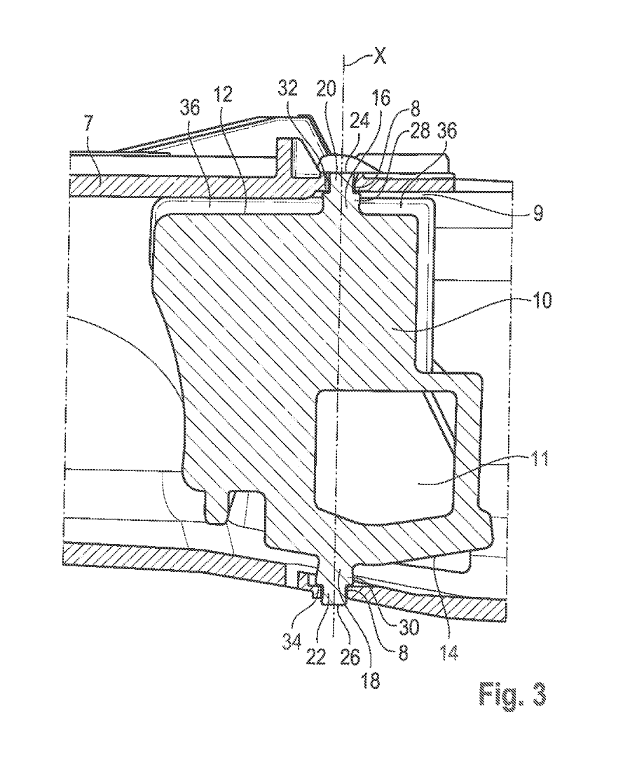

FIG. 3 shows the middle vane 10 of the air vent 5 of FIGS. 1 and 2.

The vane 10 includes two face sides 12, 14. Provided on each face side 12, 14 is a respective clip-in member 16, 18.

The clip-in members 18, 18 are of identical configuration.

The vane 10 further has a window 11 provided therein.

The clip-in members 16, 18 include clip-in sections 20, 22. The clip-in sections 20, 22 have a substantially cylindrical basic shape that widens at its end 24, 26 facing away from the respective face sides 12, 14 of the vane 10.

The ends 24, 26 of the clip-in sections 20, 22 have a mushroom head-shaped design and are rounded.

The clip-in members 16, 18 each include a shoulder 28, 30 between the ends 24, 26 and the respective face sides 12, 14, the shoulder 28, 30 defining a clip-in stop.

The shoulder 28, 30 includes a support surface 32, 34 that is intended to rest at the respective edge of the openings 8 of the air vent housing 7.

The shoulder 28, 30 widens at its end facing away from the vane 10.

Moreover, the shoulders 28, 30 are formed to have a mushroom head shape, each clip-in section 20, 22 being formed by the upper region of the shoulders 28 and 30, respectively.

The two clip-in members 16, 18 are coaxial and integrally molded with the vane.

Further provided on the face side 18 of the vane is a sealing lip 32 which seals the gap between the vane 10 and the air vent housing 7. The sealing lip 36 is formed from an elastic material and has a comparatively good sliding quality, so that it can slide on the surface of the inside of the air vent housing 7.

The assembly of the vanes 10 in the air vent 5 is effected as follows:

The vanes 10 are inserted into the air vent 5 and are then clipped into the corresponding dedicated openings 8. To this end, the air vent 5 is reversibly elastically deformed, e.g. by compression, to allow the vanes 10 to be clipped in.

The shaping of the air vent housing 7 permits, within certain limits, a flexible and reversible deformation, which is sufficient to allow the vanes to be inserted and clipped into the openings 8 in the air vent housing 7. This is also assisted by the insertion regions 9 which guide the clip-in members towards the openings 8 and in this way facilitate the insertion and clipping-in process.

The smaller wall thickness of the insertion regions 9 still further additionally allows a flexible and reversible deformation, which is required for insertion of the vanes 10.

The air vent housing 7 and also the insertion regions 9 thus have a certain elasticity, so that compression of the air vent housing 7 will give it a larger height, which allows the vanes 10 to be inserted into the respective openings 8.

In working operation of the air vent 10, the swiveling is then effected as follows:

The two clip-in members 16, 18 define an axis of rotation X, about which the vane 10 can be swiveled. The swivel motion can be specified by an operating element via coupling members not shown in more detail.

The clip-in members 16 and 18 and the sealing lip 32 cause the swiveling of the vane 10 to be effected with low noise. Any up-and-down movement of the vane 10, that is, an axial movement along the axis of rotation X, is prevented by the sealing lip 36 and the shoulders 28, 30.

1. A vane for an air vent, wherein said vane includes at least one face side, said face side having at least one clip-in member provided thereon by means of which said vane can be clipped into an air vent.

2. The vane of claim 1 wherein said clip-in member includes a clip-in section which has a substantially cylindrical basic shape and widens at an end facing away from said vane.

3. The vane of claim 1 wherein said clip-in member is at least partly formed to have a mushroom head shape.

4. The vane of claim 1 wherein said vane has two face sides, both of said face sides each having a clip-in member provided thereon.

5. The vane of claim 4 wherein said two clip-in members are Coaxial.

6. The vane of claim 1 wherein said clip-in member is integrally molded with said vane.

7. The vane of claim 1 wherein said clip-in member includes a shoulder defining a clip-in stop.

8. The vane of claim 7 wherein said shoulder widens at its end facing away from said vane.

9. The vane of claim 8 wherein said shoulder is at least partly formed to have a mushroom head shape.

10. An air vent comprising at least a vane for an air vent, wherein said vane includes at least one face side, said face side having at least one clip-in member provided thereon by means of which said vane can be clipped into an air vent.
